(19) United States
(12) Patent Application Publication
(10) Pub. No.: US 2003/0205196 A1
(43) Pub. Date: Nov. 6, 2003

(54) Substrate processing apparatus and substrate processing method

(75) Inventors: Takahiro Kitano, Kikuchi-Gun (JP); Yuji Matsuyama, Kikuchi-Gun (JP); Junichi Kitano, Nirasaki-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKYO ELECTRON LIMITED, Tokyo-To (JP)

(21) Appl. No.: 09/820,748

(22) Filed: Mar. 30, 2001

(30) Foreign Application Priority Data
Mar. 31, 2000 (JP) 2000-98430

(51) Int. Cl. B05D 3/12

(52) U.S. Cl. 118/319; 427/240

(57) ABSTRACT

A spin chuck on which a wafer is mounted is divided into a plurality of regions concentrically in a radial direction, and different temperatures are set for each of the regions so that the temperature gradually increases from the outer periphery to the center. The wafer is placed on this spin chuck, and a processing solution is applied to the wafer and spread over the wafer by centrifugal force, whereby the vaporization of a solvent of the processing solution which is spread on the outer periphery of the wafer is suppressed, and hence the timing of drying of the processing solution within the surface of the wafer can be made uniform. Consequently, a coating film with a uniform thickness within the wafer surface can be obtained.

### BACKGROUND OF THE INVENTION

1. Field of the Invention

The present invention relates to a substrate processing apparatus and a substrate processing method, for example, for coating a semiconductor wafer, a substrate for an LCD, or the like with a processing solution such as a resist.

2. Description of the Related Art

In a photolithography process of the process of fabricating a semiconductor device, for example, resist coating processing of forming a resist film on the surface of a semiconductor wafer (hereinafter referred to as “a wafer”) and developing processing for the resist-coated wafer are performed with exposure processing therebetween.

If notice is taken of the resist coating processing, a spin coating method or the like is frequently used as a method for uniformly coating the surface of the wafer with a resist solution. Resist coating by means of this spin coating method is performed as follows: the wafer is rotated while being vacuum-sucked by a spin chuck; the resist solution is dropped and supplied to the surface of the wafer from directly above the center of the rotation; and the resist solution is spread over the entire surface from the center of the wafer by centrifugal force. In a resist coating apparatus of this type, the thickness of a resist film can be controlled by the rotation speed of the spin chuck (wafer). Namely, with an increase in rotation speed, a thinner resist film can be obtained.

In spreading the resist solution by centrifugal force while rotating the wafer, however, the resist solution which is spread to the outer periphery of the wafer tends to cure from the outer periphery since the vaporization of a solvent is faster compared with the resist solution at the center of the wafer. Therefore, there is a problem that a resist film with an ununiform thickness is formed within the wafer surface. Especially when a thin resist film is required, such a problem is noteworthy.

### SUMMARY OF THE INVENTION

An object of the present invention is to provide a substrate processing apparatus and a substrate processing method capable of forming a coating film with a uniform thickness within the surface of a substrate on the substrate.

To attain the aforesaid object, a substrate processing apparatus according to a main aspect of the present invention comprises: a holder having a holding surface which holds a substrate, for rotatably holding the substrate; a nozzle for supplying a solution onto the substrate held by the holder; heaters disposed respectively in a plurality of regions into which the holding surface is divided almost concentrically from almost an exact rotation center to an outer periphery of the holding surface; and a controller for individually controlling temperatures of the respective heaters.

In the present invention, for example, when a processing solution is applied on the substrate and spread over the substrate by centrifugal force by rotating the substrate, the substrate is set to have such a temperature distribution that the temperature increases gradually from the outer periphery to the center of the substrate, whereby the vaporization of a solvent of the processing solution which is spread on the outer periphery of the substrate is suppressed and the timing of drying of the processing solution within the surface of the substrate can be made almost uniform. Accordingly, a coating film having a uniform thickness within the substrate surface can be obtained.

A substrate processing apparatus according to another aspect of the present invention comprises: a holder having a holding surface which holds a substrate, capable of rotating while holding the substrate by the holding surface, the holding surface being set at different temperatures depending on regions, and a nozzle for supplying a solution onto the substrate held by the holder.

In the present invention, the substrate can be set to have different temperatures within the surface of the substrate. Therefore, for example, when the processing solution is applied on the substrate and spread over the substrate by rotating the substrate, a region where the vaporization of the solvent of the processing solution is outstanding is set at a lower temperature, whereby the timing of drying of the processing solution within the substrate surface can be made almost uniform. Accordingly, a coating film having a uniform thickness within the substrate surface can be obtained.

A substrate processing method according to still another aspect of the present invention is a substrate processing method for supplying a solution onto a substrate held by a holding surface for holding the substrate, comprising: a step of controlling a temperature of the holding surface separately according to regions of the holding surface; and a step of holding the substrate, onto which the solution is supplied, by the temperature-controlled holding surface.

In the present invention, for example, when a processing solution is spread over the substrate by centrifugal force by rotating the substrate, the substrate is set to have such a temperature distribution that the temperature increases gradually from the outer periphery to the center of the substrate, whereby the vaporization of a solvent of the processing solution which is spread on the outer periphery of the substrate is suppressed and the timing of drying of the processing solution within the surface of the substrate can be made almost uniform. Accordingly, a coating film having a uniform thickness within the substrate surface can be obtained.

These objects and still other objects and advantages of the present invention will become apparent upon reading the following specification when taken in conjunction with the accompanying drawings.

### BRIEF DESCRIPTION OF THE DRAWINGS

FIG. 1 is a plan view of a resist coating and developing system according to an embodiment of the present invention;

FIG. 2 is a front view of the resist coating and developing system in FIG. 1;

FIG. 3 is a rear view of the resist coating and developing system in FIG. 1;

FIG. 4 is a perspective view of a transfer device in the resist coating and developing system shown in FIG. 1;

FIG. 5 is a sectional view showing the entire structure of a resist coating unit according to the embodiment of the present invention;

FIG. 6 is a plan view of the resist coating unit shown in FIG. 5;

FIG. 7 is a schematic plan view of a spin chuck shown in FIG. 5 and FIG. 6;

FIG. 8 is a schematic sectional view of the spin chuck shown in FIG. 7;

FIG. 9 is a diagram showing an example of a temperature distribution of the spin chuck shown in FIG. 7 and FIG. 8;

FIG. 10 is a diagram showing another example of the spin chuck;

FIG. 11 is a diagram for explaining another embodiment;

FIG. 12 is a sectional view showing the entire structure of a developing processing unit to which the present invention is applied;

FIG. 13 is a plan view of the developing processing unit shown in FIG. 12; and

FIG. 14 is a diagram showing an example of a temperature distribution of a spin chuck in the developing processing unit shown in FIG. 12 and FIG. 13.

### DETAILED DESCRIPTION OF THE PREFERRED EMBODIMENT

Embodiments in which the present invention is applied to a resist coating and developing system for coating a semiconductor wafer with a resist solution to and develops the resist will be explained below with reference to the drawings.

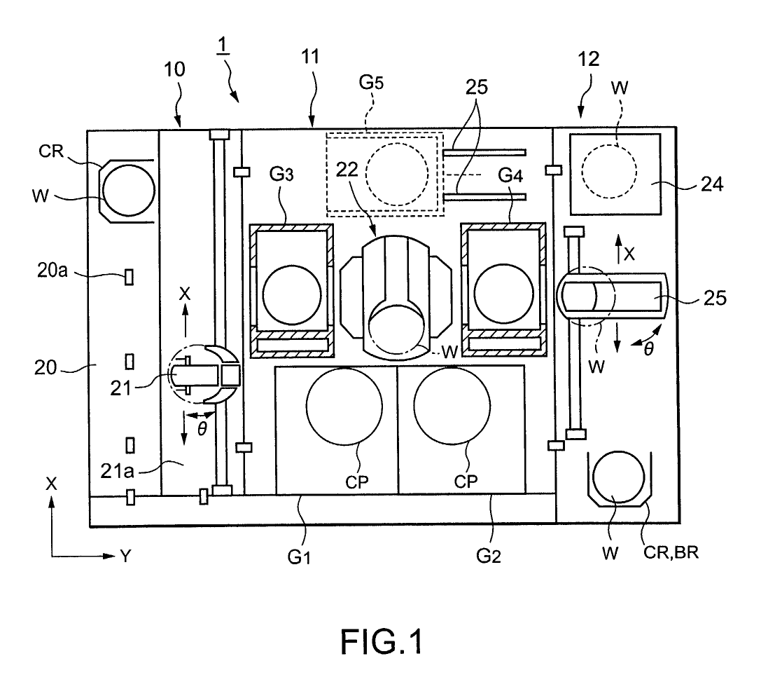

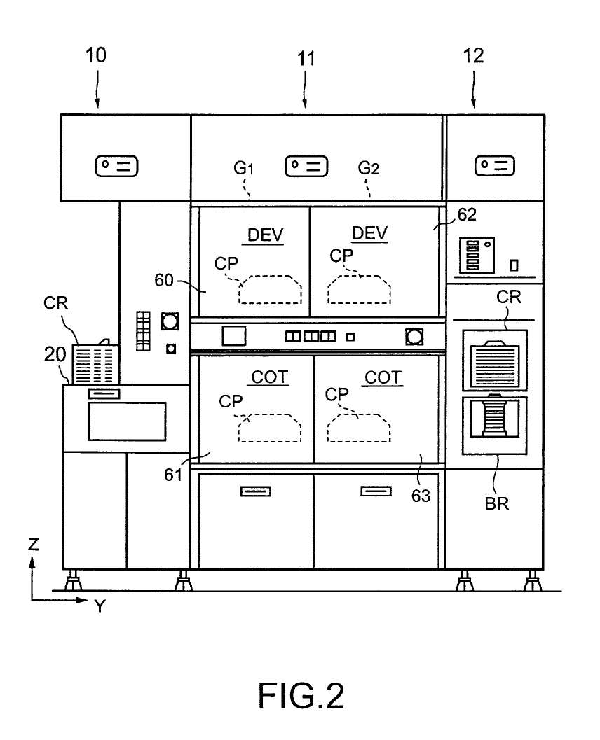

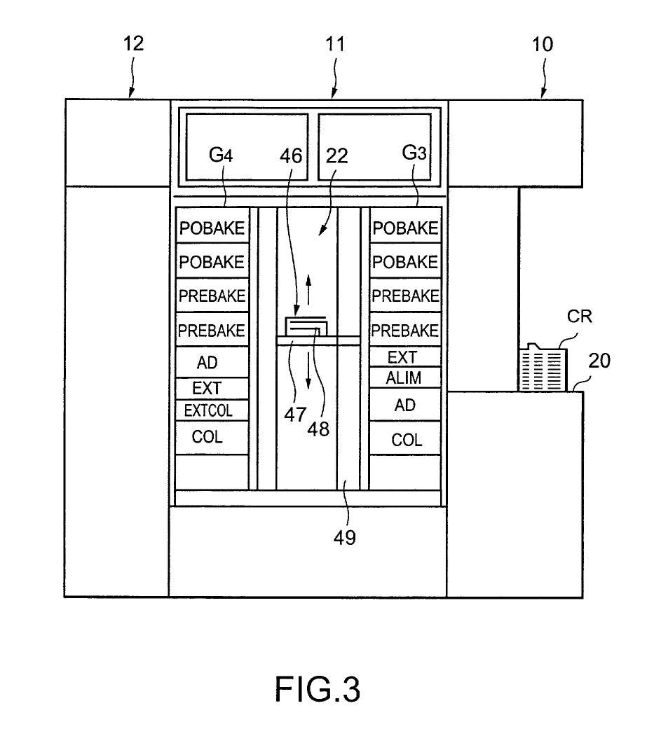

FIG. 1 is a plan view of a resist coating and developing system according to this embodiment, FIG. 2 is a front view of the resist coating and developing system shown in FIG. 1, and FIG. 3 is a rear view of the resist coating and developing system shown in FIG. 1.

As shown in FIG. 1, this resist coating and developing system 1 has a structure in which a cassette station 10, a processing station 11, and an interface unit 12 are integrally connected. In the cassette station 10, a plurality of, for example, 25 wafers W per cassette C, as a unit, are transferred from/to the outside into/from the resist coating and developing system 1, and moreover the wafer W is carried into/out of the cassette C. In the processing station 11, various kinds of processing units which perform predetermined processing for the wafers W one by one in a coating and developing process and are stacked in multiple tiers at predetermined positions. In the interface unit 12, the wafer W is delivered from/to an aligner provided adjacent to the resist coating and developing system 1.

In the cassette station 10, a plurality of, for example, four cassettes C are mounted in a line in an X-direction (in a top-to-bottom direction in FIG. 1) at the positions of positioning projections 20a on a cassette mounting table 20 with respective transfer ports for the wafer W facing the processing station 11 side. A wafer transfer device 21 movable in the direction of arrangement of the cassettes C (the X-direction) and in the direction of arrangement of the wafers W housed in the cassette C (a Z-direction, i.e., vertical direction) can freely move along a transfer path 21a and selectively get access to each of the cassettes C.

The wafer transfer device 21 is structured to be rotatable in a θ-direction so as to get access to an alignment unit (ALIM) and an extension unit (EXT) included in units staked in multiple tiers of a third processing unit group G3 on the processing station 11 side as will be described later.

In the processing station 11, as shown in FIG. 1, a vertical-transfer type transfer device 22 is disposed at the center thereof, and around the transfer device 22, various processing units are stacked in multiple tiers to compose one or a plurality of processing unit groups. In this resist coating and developing system 1, five processing unit groups G1, G2, G3, G4, and G5 can be disposed. The first and second processing unit groups G1 and G2 are disposed on the front side of this system. The third processing unit group G3 is disposed adjacent to the cassette station 10. The fourth processing unit group G4 is disposed adjacent to the interface unit 12. The fifth processing unit group G5 shown by a broken line can be disposed on the rear side. The transfer device 22 is structured to be freely rotatable in the θ-direction and movable in the Z-direction so as to be able to receive and send the wafer W from/to the respective processing units.

In the first processing unit group G1, as shown in FIG. 2, two spinner-type processing units each of which performs predetermined processing while the wafer W is mounted on a spin chuck within a cup CP, for example, a resist coating unit (COT) 61 and a developing processing unit (DEV) 60 are stacked in two tiers from the bottom in order. Similarly to the first processing unit group G1, in the second processing unit group G2, two spinner-type processing units, for example, a resist coating unit (COT) 63 and a developing processing unit (DEV) 62 are stacked in two tiers from the bottom in order.

In the third processing unit group G3, as shown in FIG. 3, oven-type processing units each of which performs predetermined processing while the wafer W is mounted on a mounting table (not illustrated), for example, a cooling processing unit (COL) which performs cooling processing, an adhesion processing unit (AD) which performs so-called hydrophobic processing for enhancing adhesion of a resist, an alignment unit (ALIM) which aligns the wafer W, an extension unit (EXT), heat processing units (PREBAKE) each of which performs pre-bake, and heat processing units (POBAKE) each of which performs post-bake are stacked in eight tiers from the bottom in order.

Similarly, in the fourth processing unit group G4, oven-type processing units each of which performs predetermined processing while the wafer W is mounted on a mounting table, for example, a cooling processing unit (COL) which performs cooling processing, an extension and cooling processing unit (EXTCOL) which performs cooling processing also, an extension unit (EXT), an adhesion processing unit (AD), heat processing units (PREBAKE) each of which performs pre-bake, and heat processing units (POBAKE) each of which performs post-bake are stacked in eight tiers from the bottom in order.

As shown in FIG. 1, the interface unit 12 is set at the same size as the processing station 11 in a depth direction (the X-direction), but at a smaller size than that in a width direction. As shown in FIG. 1 and FIG. 2, a transportable pickup cassette CR and a fixed-type buffer cassette BR are stacked in two tiers at the front of the interface unit 12, and a peripheral edge aligner 24 is disposed at the rear.

A wafer transfer device 25 is provided at the center of the interface unit 12. The wafer transfer device 25 moves in the X-direction and the Z-direction (vertical direction) to be able to get access to both the cassettes CR and BR, and the peripheral edge aligner 24. The wafer transfer device 25 is also structured to be rotatable in the θ-direction to be able to get access to the extension unit (EXT) included in the fourth processing unit group G4 on the processing station 11 side and a wafer delivery table (not illustrated) on the adjoining aligner side.

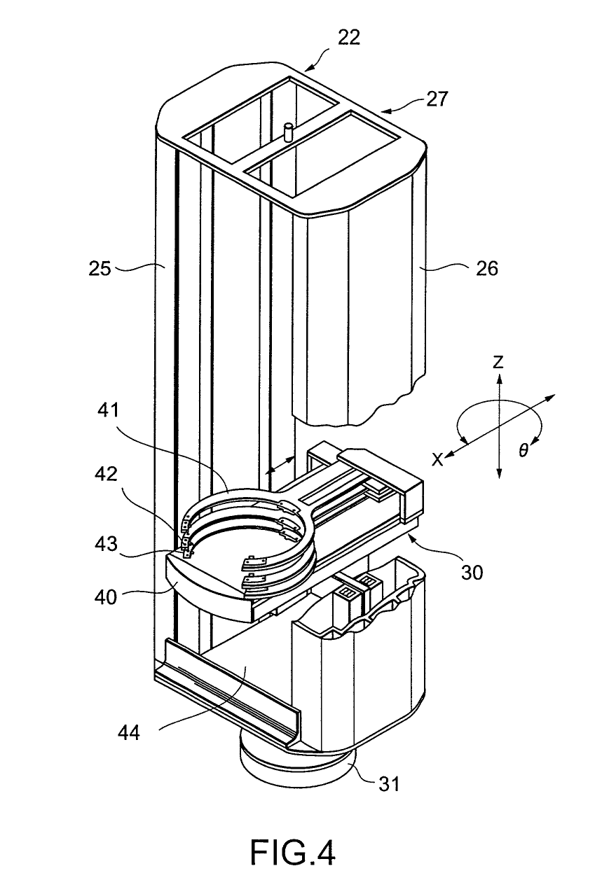

FIG. 4 is a perspective view showing the external appearance of the transfer device 22. This transfer device 22 is provided with a wafer carrier 30 which is ascendable and descendable vertically (in the Z-direction) inside a cylindrical supporter 27 composed of a pair of walls 25 and 26 which are connected to each other at their upper ends and lower ends and face each other. The cylindrical supporter 27 is connected to a rotating shaft of a motor 31, and rotated around the rotating shaft integrally with the wafer carrier 30 by rotational driving force of the motor 31. Therefore, the wafer carrier 30 is freely rotatable in the θ-direction. For example, three tweezers are provided on a transfer base 40 of this wafer carrier 30. These three tweezers 41, 42, and 43 each have a shape and a size capable of passing through a side opening 44 between both the walls 25 and 26 of the cylindrical supporter 27, and they are structured to be freely movable back and forth along the X-direction. The transfer device 22 allows the tweezers 41, 42, and 43 to get access to the processing units disposed around the transfer device 22 to receive and send the wafer W from/to these processing units.

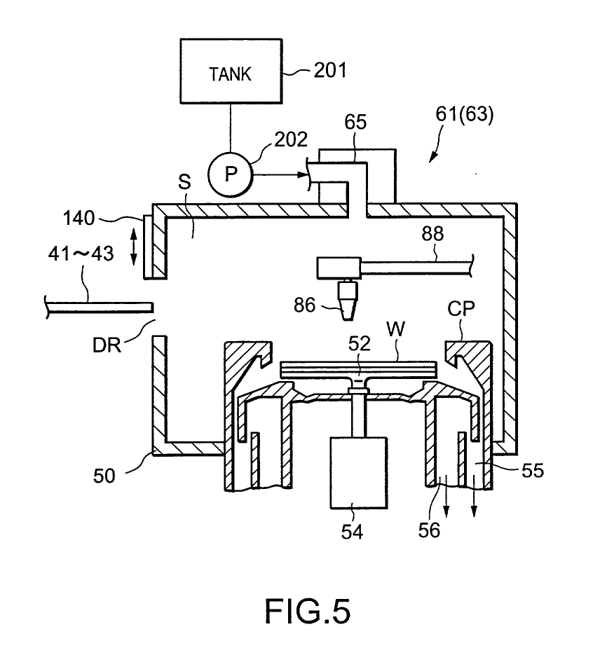

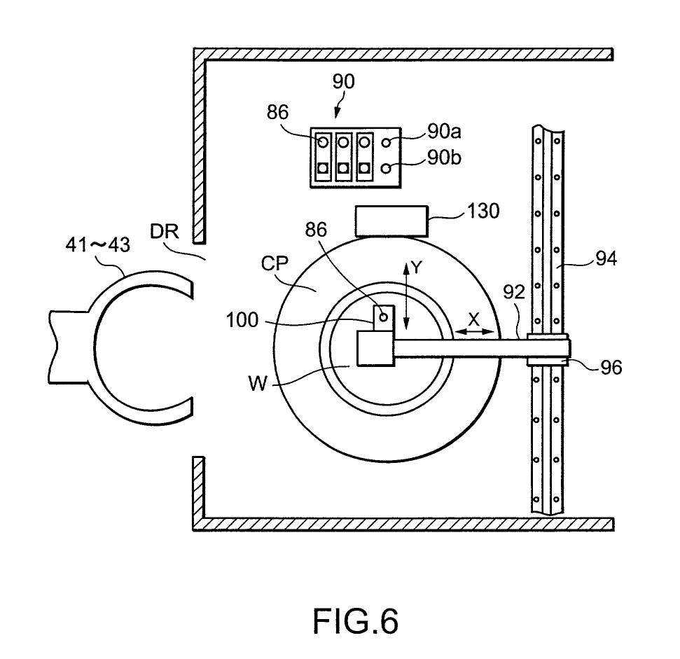

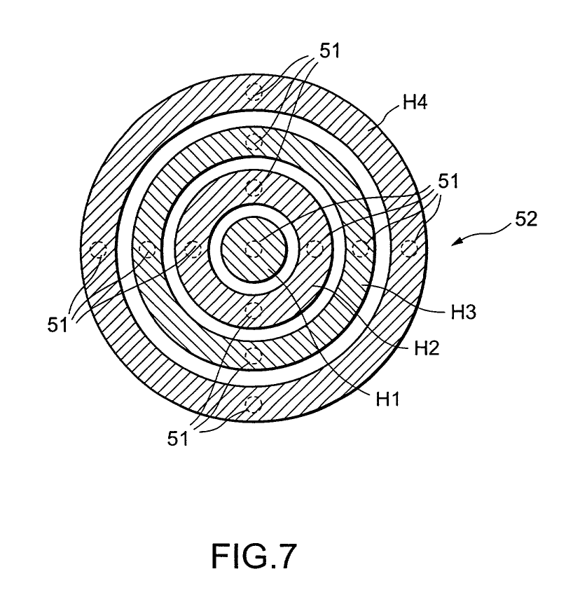

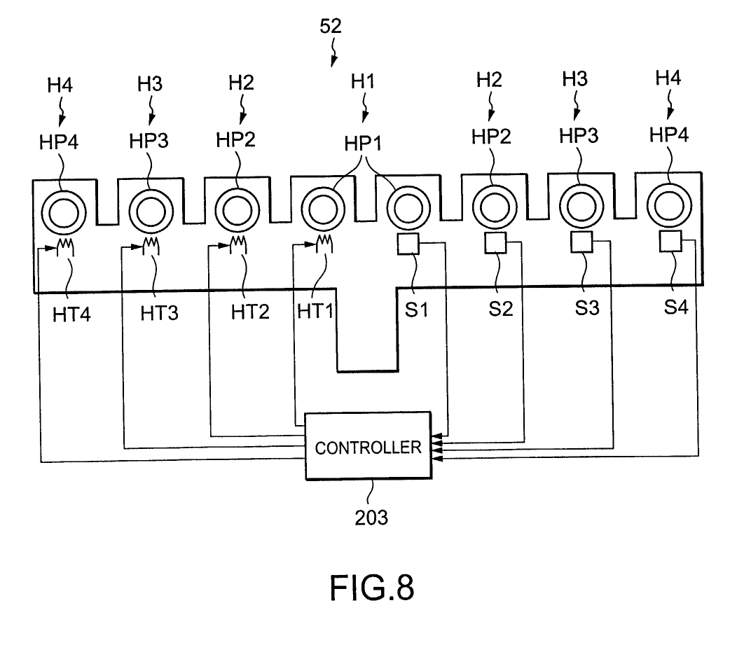

FIG. 5 is a schematic sectional view showing the entire structure of the aforesaid resist coating unit (COT) 61 (63) according to the present invention, and FIG. 6 is a schematic plan view thereof. FIG. 7 is a schematic plan view of a spin chuck, and FIG. 8 is a schematic sectional view thereof.

As shown in FIG. 5 and FIG. 6, in the resist coating unit (COT) 61 (63), an annular cup CP is provided at the center of the bottom of the unit, and a spin chuck 52 is placed inside the cup CP. The cup CP is placed inside a processing chamber 50 having an opening DR. The processing chamber 50 is provided with an ascendable and descendable shutter 140 for opening and closing the opening DR. On the occasion of coating of a resist solution, the shutter 140 descends to close the opening DR, thereby forming an enclosed space. Meanwhile, on the occasion of carrying in and out of the wafer W, the shutter 140 ascends, and the tweezers 41 to 43 of the transfer device 22 go into and out of the processing chamber 50 through the opening DR. A thinner, vapor, or the like which is a gas produced by vaporizing a solvent of the resist solution is introduced into an enclosed space S formed by the descent of shutter 140 from a tank 201 via a pump 202 through an inlet pipe 65 provided on the ceiling of the processing chamber 50. Thus, by introducing the gas, the interior of the processing chamber 50 is in a pressurized state on the occasion of coating of the resist solution. In this embodiment, the pressure in the processing chamber on the occasion of coating of the resist solution is set to be higher than a normal pressure, for example, set at 1.1×10⁵ Pa. This setting at a high pressure makes it possible to suppress the vaporization of the solvent of the resist solution and to make a resist film thinner. Moreover, a solvent atmosphere is maintained in the processing chamber at the time of coating of the resist solution, and hence the temperature in the processing chamber is set at, for example, 23.0° C. at the time of coating of the resist solution.

The spin chuck 52 is structured to be rotated by rotational driving force of a motor 54 while fixedly holding the wafer W by vacuum suction. The drive motor 54 is placed so as to be able to be raised and lowered by a cylinder not illustrated, and thereby the spin chuck 52 can be raised and lowered. A drain port 55 for a waist solution and a drain port 56 for an exhaust gas are provided separately in the cup CP.

A resist solution supply nozzle 86 for supplying the resist solution as a processing solution to the surface of the wafer W is connected to a resist solution supply unit (not illustrated) via a resist solution supply pipe 88. The resist solution supply nozzle 86 is removably attached to the tip of a nozzle scan arm 92 at a nozzle waiting position 90 outside the cup CP, and moved to a predetermined solution discharge position which is set at a position above the spin chuck 52. The nozzle scan arm 92 is attached to the upper end of a vertical support 96 which is horizontally movable on guide rails 94 laid in one direction (the Y-direction) inside the processing chamber 50, and moves in the Y-direction integrally with the vertical support 96 by a Y-direction drive mechanism not illustrated.

The nozzle scan arm 92 is also movable in the X-direction perpendicular to the Y-direction in order to selectively attach the resist solution supply nozzle 86 thereto at the nozzle waiting position 90, and moves in the X-direction by an X-direction drive mechanism not illustrated.

At the nozzle waiting position 90, a discharge port of the resist solution supply nozzle 86 is inserted into a hole 90a of a solvent atmosphere chamber and exposed to a solvent atmosphere therein, whereby the solution at the tip of the nozzle does not solidify nor deteriorate.

Moreover, a drain cup 130 is provided between the cup CP and the nozzle waiting position 90, and the resist solution supply nozzle 86 is cleaned at this position before the supply of the resist solution to the wafer W.

As shown in FIG. 7, the spin chuck 52 is circular with almost the same size as the wafer W, and its center is aligned with the center at the time of rotational drive of the wafer. For example, a plurality of suction ports 51 are provided in the spin chuck 52, and the wafer W is suction-held on the spin chuck 52 via the suction ports 51. The suction port 51 may be provided only at one position. Further, the spin chuck 52 is divided into a plurality of regions, for example, four regions H1 to H4 concentrically in a radial direction.

As shown in FIG. 8, heat pipes HP1 to HP4 which are independent of one another are embedded in the respective regions H1 to H4 of the spin chuck 52, and temperature sensors S1 to S4 and heaters HT1 to HT4 are disposed directly below the heat pipes HP1 to HP4 respectively. A controller 203 controls the supply of electric power to the respective heaters HT1 to HT 4 based on temperatures detected by the respective sensors S1 to S4.

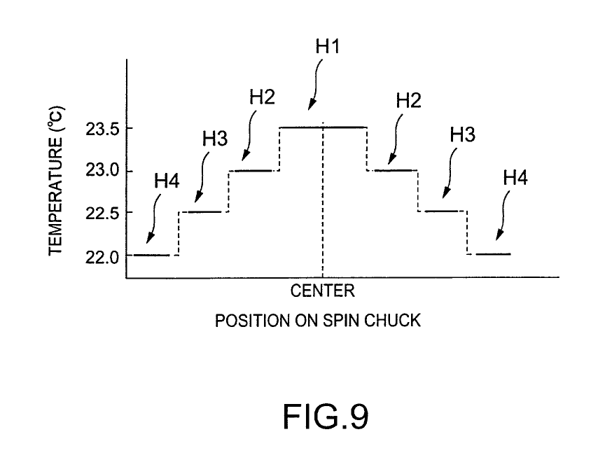

FIG. 9 is a diagram showing one example of a temperature distribution of the spin chuck 52 under such control. The vertical axis shows temperatures, and the horizontal axis shows positions along the diameter of the spin chuck 52. As shown in FIG. 9, in this embodiment, the temperature of the region H1 is set at 23.5° C., the temperature of the region H2 is set at 23.0° C., the temperature of the region H3 is set at 22.5° C., and the temperature of the region H4 is set at 22.0° C. Further, it is desirable to set the temperature of the region H4 which corresponds to the outer periphery of the wafer W at a temperature at which at least the vaporization of the solvent of the resist solution is suppressed, and thus the vaporization of the solvent at the outer periphery is suppressed. Incidentally, in this embodiment, a thinner with a boiling point of about 120° C. at the normal pressure is used as the solvent of the resist solution. The temperature setting for the wafer W by the temperature controller may be suitably controlled according to a temperature at which the solvent vaporizes, a pressure in the processing chamber, an atmosphere in the processing chamber, a temperature in the processing chamber, a temperature of the resist solution, and the like.

As described above, the temperature of the spin chuck 52 is controlled so that the temperature increases gradually from the outer periphery to the center of the wafer W, whereby the wafer W held on this spin chuck 52 has such a temperature distribution that the temperature increases gradually from the outer periphery to the center. Thus, when the resist solution is applied while being spread over the wafer W by a spin-coating method, the vaporization of the solvent of the resist solution which is spread on the outer periphery is suppressed, resulting in uniformity of the timing of drying of the resist solution within the surface of the wafer W.

Next, the operation of the aforesaid resist coating unit (COT) 61 (63) will be explained by means of FIG. 5 to FIG. 7.

The temperature in the processing chamber 50 is maintained at a normal temperature before the wafer W is transferred thereto. The spin chuck 52 in the processing chamber 50 moves to the outside of the cup CP with the ascent of the drive motor 54. The wafer W held by any one of the tweezers 41 to 43 of the transfer device 22 is transferred into the processing chamber 50 through the opening DR and mounted on the spin chuck 52. The wafer W is suction-held by the spin chuck 52, and moves to a resist solution coating position inside the cup CP with the descent of the spin chuck 52. The opening DR is closed by the shutter 140.

After the wafer W is carried into the processing chamber 50, a gas produced by vaporizing the solvent of the resist solution is introduced into the processing chamber 50 through the inlet pipe 65, whereby a solvent atmosphere is kept in the processing chamber 50 and the pressure in the processing chamber 50 is set at 1.1×10⁵ Pa. The temperature in the processing chamber 50 is set at 23.0° C. A thinner, for example, is used as the solvent. The wafer W is set to have such a temperature distribution that the temperature increases gradually from the outer periphery to the center by the heat pipes as heaters. In this case, the maintenance of the solvent atmosphere inside the processing chamber 50 enables the suppression of the vaporization of the solvent of the resist solution. Moreover, the pressure in the processing chamber 50 is set to be higher than the normal pressure, thereby further suppressing the vaporization of the solvent and facilitating the thinning of the resist film.

Subsequently, the resist solution supply nozzle 86 moves to the center of the wafer W. The resist solution is supplied to the wafer W from the resist solution supply nozzle 86 while the wafer W is rotated at a speed of 2000 rpm. The resist solution supplied onto the wafer W is spread over the wafer W by centrifugal force to form a coating film on the wafer W. On this occasion, since the wafer W is set to have such a temperature distribution that the temperature increases gradually from the outer periphery to the center of the wafer W, the vaporization of the solvent of the resist solution which is spread on the outer periphery of the wafer W is suppressed, whereby the timing of drying of the resist solution within the surface of the wafer W can be made uniform. Accordingly, a coating film with a uniform thickness within the wafer surface can be obtained, and, for example, even in the case of a thin film 100 nm in thickness, a coating film with a uniform thickness within the wafer surface can be formed.

After the pressurized state inside the processing chamber 50 is released and the temperature in the processing chamber 50 returns to the normal temperature, the shutter 140 is raised and the wafer W is raised. Any one of the tweezers 41 to 43 of the transfer device 22 is then inserted into the processing chamber 50 through the opening DR to carry the wafer on which the coating film is formed out of the processing chamber 50, and thus a resist coating process is completed.

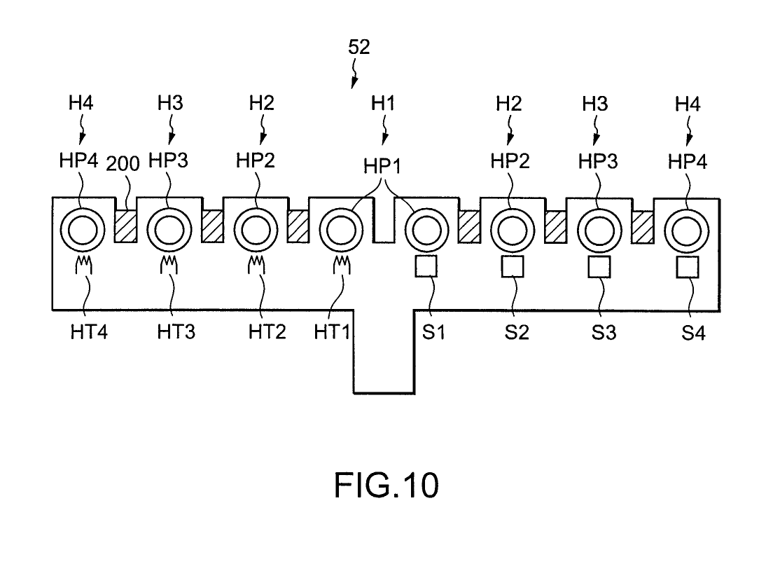

Incidentally, as for the structure of the spin chuck 52, heat insulators 200 may be put in spaces between the heat pipes HP1 to HP4 as shown in FIG. 10. As a result, thermal interference between the respective regions can be prevented, which enables more precise temperature control.

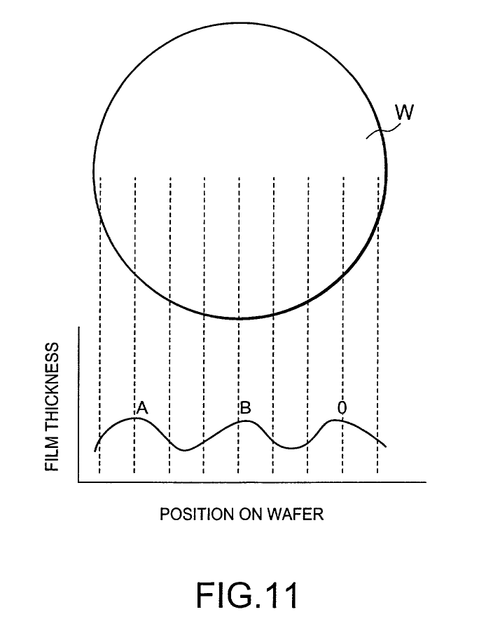

As shown in FIG. 11, it is also suitable to obtain a film thickness profile of the wafer W and individually control temperatures at respective positions on the spin chuck 52 according to a film thickness at each position on the wafer W. As for temperature control corresponding to A, B, and C shown in FIG. 11, for example, such a control that the temperature is decreased is recommended.

Furthermore, in the aforesaid embodiment, when the solvent is attached to the resist solution supply nozzle as dewdrops by cold or heat for controlling the temperature in the processing chamber, it is also possible to provide a temperature controller such as a heater in the nozzle.

Although the example in which the present invention is applied to the unit for coating the semiconductor wafer with the resist solution and the like is explained, the present invention can be applied to a unit for coating substrates other than the semiconductor wafer, for example, an LCD substrate with a resist solution, or the like.

Next, an embodiment in which the present invention is applied to the developing processing units (DEV) 60 and 62 in the aforesaid system will be explained.

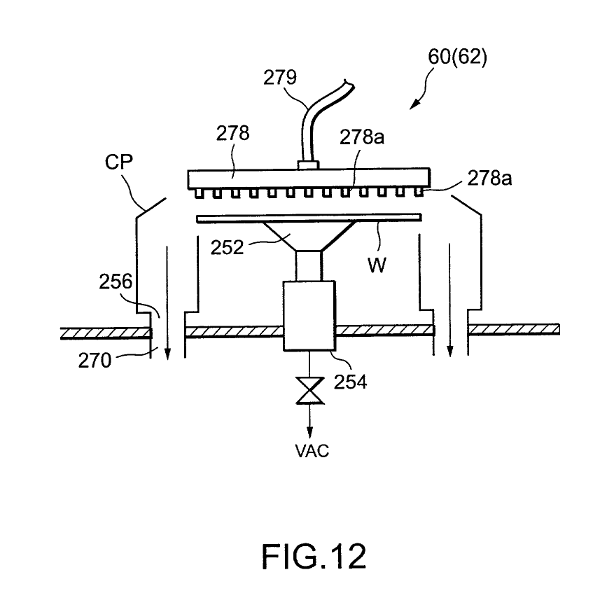

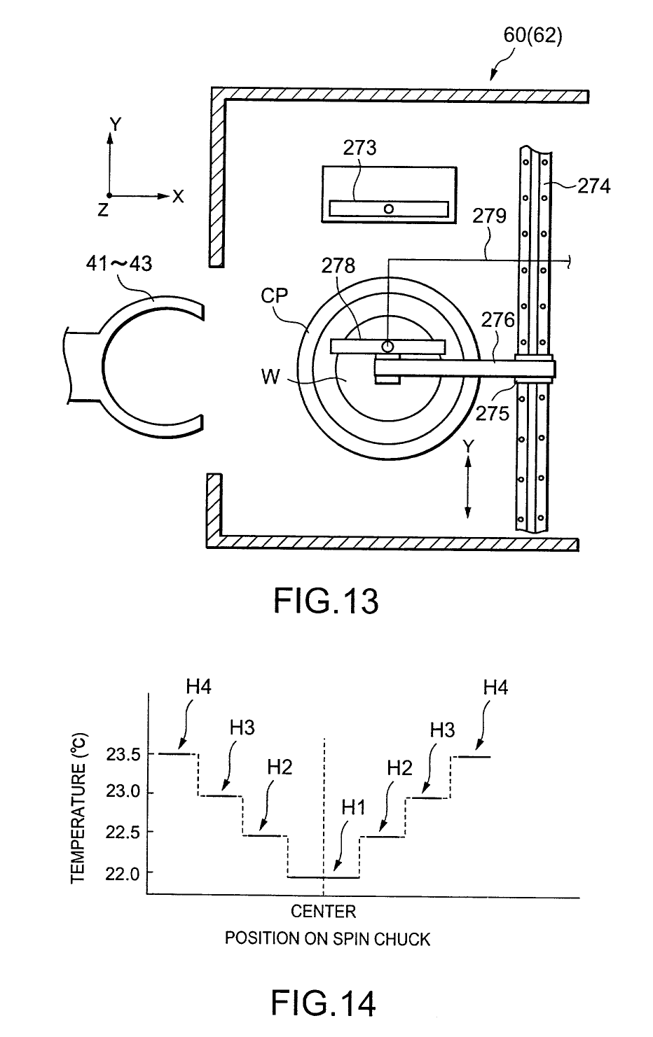

FIG. 12 and FIG. 13 are a schematic plan view and a schematic sectional view showing the entire structure of the developing processing unit (DEV) 60 (62).

In this developing processing unit (DEV) 60, a cup CP which houses the wafer W is placed in the vicinity of the center of the unit. A processing solution supply nozzle 278 which supplies a developing solution to the wafer W is removably attached to a nozzle scan arm 276. The nozzle scan arm 276 is attached to the upper end of a vertical support 275 which is horizontally movable on guide rails 274 laid outside the cup CP, and moves in the Y-direction integrally with the vertical support 275 by the driving of a drive unit. The processing solution supply nozzle 278 is connected to a solution supply source of the developing solution not illustrated via a solution supply pipe 279. A plurality of discharge ports 238a for discharging the processing solution are provided in a line in the longitudinal direction of the nozzle 278 at the bottom of the nozzle 278.

A rinse nozzle 273 which discharges a rinse solution for rinsing the developing solution away after the supply of the developing solution to the wafer W is prepared outside the cup CP and timely moved onto the wafer W by the nozzle scan arm 276.

One chamber is formed by an outer peripheral wall, an inner peripheral wall, and a bottom wall inside the cup CP. One or a plurality of drain ports 256 are provided in the bottom wall, and this drain port 256 is connected to a tank not illustrated via a drain pipe 270. On the occasion of developing processing, the processing solution which has overflowed is collected into the cup CP and sent as a waste solution from the drain port 256 in the bottom of the cup CP to the tank not illustrated through the drain pipe 270.

A spin chuck 252 as a holder which holds the wafer W by vacuum suction when the wafer W is delivered by transfer arms 41 to 43 is provided at the center inside the cup CP. This spin chuck 252 can be raised and lowered, and rotated while fixedly holding the wafer W by a drive motor 254.

In this case, the spin chuck 252 has the same structure as that shown in FIG. 8.

In the developing processing unit (DEV) 60 thus structured, the wafer W is delivered from the transfer arm 41 to 43 to the spin chuck 252, and thereafter the spin chuck 252 is lowered. The developing solution is then supplied onto the wafer W from the processing solution supply nozzle 278 while the wafer W is rotated.

Subsequently, the rotation of the spin chuck 252 is stopped, and static developing is performed for a predetermined period of time. On this occasion, as shown in FIG. 14, the temperature of the spin chuck 252 is controlled so that the temperature decreases gradually from the outer periphery to the center of a wafer W holding surface of the spin chuck 252, whereby the wafer W held on this spin chuck 252 has such a temperature distribution that the temperature decreases gradually from the outer periphery to the center. As a result, temperatures of the wafer W to which the developing solution is supplied are made uniform, resulting in uniform developing. Thereafter, rinse processing is performed.

The disclosure of Japanese Patent Application No.2000-98430 filed Mar. 31, 2000 including specification, drawings and claims are herein incorporated by reference in its entirety.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

What is claimed is:

1. A substrate processing apparatus, comprising:
a holder having a holding surface which holds a substrate, for rotatably holding the substrate;
a nozzle for supplying a solution onto the substrate held by the holder;
heaters disposed respectively in a plurality of regions into which the holding surface is divided almost concentrically from almost an exact rotation center to an outer periphery of the holding surface; and
a controller for individually controlling temperatures of the respective heaters.

2. The apparatus as set forth in claim 1,
wherein the solution is a resist solution, and
wherein the controller performs a temperature control so that a temperature of each of the regions gradually decreases from almost the exact rotation center to the outer periphery of the holding surface.

3. The apparatus as set forth in claim 1,
wherein the solution is a resist solution, and
wherein the controller controls a temperature of each of the regions according to a profile of a film thickness of a resist formed on the substrate.

4. The apparatus as set forth in claim 1, further comprising:
a processing chamber capable of being closed tightly where the solution is supplied onto the substrate held by the holder from the nozzle.

5. The apparatus as set forth in claim 4, further comprising:
a pressurizing mechanism for pressurizing an interior of the processing chamber.

6. The apparatus as set forth in claim 5,
wherein the solution contains a processing solution and a solvent, and
wherein the pressurizing mechanism pressurizes the interior of the processing chamber by introducing a gas of an atmosphere of the solvent into the processing chamber.

7. The apparatus as set forth in claim 1, further comprising:
a plurality of temperature detectors provided in the respective regions,
the controller performing temperature control so that each of the regions reaches its desired temperature according to a temperature detected by each of the temperature detectors.

8. The apparatus as set forth in claim 1,
wherein the solution is a developing solution, and
wherein the controller performs temperature control so that a temperature of each of the regions gradually increases from almost the exact rotation center to the outer periphery of the holding surface.

9. The apparatus as set forth in claim 1, further comprising
a heat insulator provided in a boundary between the respective regions which adjoin each other in the holder.

10. A substrate processing apparatus, comprising:
a holder having a holding surface which holds a substrate, capable of rotating while holding the substrate by the holding surface, the holding surface being set at different temperatures depending on regions, and
a nozzle for supplying a solution onto the substrate held by the holder.

11. The apparatus as set forth in claim 10,
wherein a temperature of the holding surface is set so as to gradually increase from an outer periphery to a center of the substrate.

12. The apparatus as set forth in claim 10,
wherein the holding surface is divided into a plurality of regions concentrically from a center of the holding surface, and the respective regions are set at different temperatures.

13. A substrate processing method for supplying a solution onto a substrate held by a holding surface for holding the substrate, comprising:
(a) a step of controlling a temperature of the holding surface separately according to regions of the holding surface; and
(b) a step of holding the substrate, onto which the solution is supplied, by the temperature-controlled holding surface.

14. The method as set forth in claim 13,
wherein the solution is a resist solution,
wherein the step (b) includes a step of supplying the solution onto the substrate while the substrate is held by the holding surface and rotated, and
wherein the step (a) is to control the temperature of the holding surface so that the temperature increases gradually from an outer periphery to a center of the substrate.

15. The method as set forth in claim 14,
wherein the step (b) is performed in a pressurized enclosed space.

16. The method as set forth in claim 15,
wherein the enclosed space is pressurized by introducing a gas of an atmosphere of a solvent contained in the solution into the enclosed space.

17. The method as set forth in claim 13, further comprising:
a step of detecting a temperature of each of the regions,
wherein the step (a) is to control the temperature so that each of the regions reaches its desired temperature according to the detected temperature.

18. The method as set forth in claim 13,
wherein the solution is a developing solution, and
wherein the step (a) is to control the temperature of the holding surface so that the temperature decreases gradually from an outer periphery to a center of the substrate.
